(19) United States
(12) Patent Application Publication
(10) Pub. No.: US 2026/0368233 A1
(43) Pub. Date: Nov. 19, 2026

(54) AUTOMATED DOCUMENT PLANNING AND REPORT GENERATION

(71) Applicant: Waypoint Transit, Inc., San Francisco, CA (US)

(72) Inventors: Varun Tandon, San Francisco, CA (US); Ryan Johnston, New York, NY (US)

(21) Appl. No.: 19/680,231

(22) Filed: May 18, 2026

Related U.S. Application Data
(60) Provisional application No. 63/807,365, filed on May 16, 2025.

(51) Int. Cl. G06F 16/338; G06F 16/31; G06F 16/332; G06F 16/334; G06F 40/30; G06V 30/414

(52) U.S. Cl. CPC G06F 16/338; G06F 16/31; G06F 16/332; G06F 16/3347; G06F 40/30; G06V 30/414

(57) ABSTRACT

Systems and methods for automated report generation using large language models (LLMs). The LLMs may receive an intent of a report from a user and perform an electronic resource review process based on the received intent. The review process may generate initial queries based on the intent and search one or more data sources using the initial queries. The retrieved documents may be used to generate a vector database and complementary search indexes. Outlines for the retrieved documents may be extracted and used to generate a report outline corresponding to an output report to be generated. The LLMs may perform a recursive question expansion process based on the intent and the extracted outlines. The LLMs may then be prompted to generate an output report based on answers from the recursive question expansion process and generated report outline. Output generation may further comprise an iterative graphic generation loop.

### CROSS-REFERENCE TO RELATED APPLICATIONS

This application claims the benefit of priority to U.S. Provisional Application No. 63/807,365, filed on May 16, 2025, which is hereby incorporated by reference in its entirety.

### FIELD

The present invention relates generally to systems, tools and methods to automate document planning and report generation.

### SUMMARY

The systems and methods described herein provide for automated study generation. The system may comprise an application server, wherein the application server may be configured to generate a report. In some embodiments, the report generation may be performed by one or more machine learning models.

In some embodiments, the report generation may comprise receiving, from a user, an intent corresponding to a study type and performing, by an electronic resource review module, an electronic resource review. The electronic resource review may comprise analyzing the intent and generating one or more initial queries based on analyzing the intent. The one or more initial queries may then be used for searching one or more data sources. One or more related documents from the one or more data sources may then be retrieved based on results of the searching. A vector database and one or more complementary search indexes may be generated from the one or more related documents. A detailed outline may be extracted for each of the one or more related documents.

In some embodiments, a question generation module may generate an initial question set wherein the initial question set may comprise one or more questions. An answer retrieval module may then retrieve one or more answers corresponding to each question. The question generation module may then expand the initial question set.

In some embodiments, expanding may comprise recursively generating one or more child questions based on the retrieved answers. A planning module may then generate a report outline based at least in part on the detailed outlines extracted for each of the one or more related documents.

In some embodiments, a report generation module may be configured to generate textual information for each section of the report outline. The textual information may be based on one or more questions associated with each section and their retrieved answers.

In some embodiments, a graphics generation module may generate one or more graphic visualizations corresponding to one or more sections of the report outline.

In some embodiments, an output generation module may be configured to combine the one or more graphic visualizations and generated textual information with the report outline into a formatted report document. The formatted report may then be output to the user.

In some embodiments, the intent may comprise one or more questions to be answered, references to relevant information and/or an example of a previously generated study.

In some embodiments, generating the vector database may comprise determining, for each of the one or more related documents, a document type and computing, for each of the one or more related documents, an embedding. The embedding may be based at least in part on the determined document type.

In some embodiments, computing the embedding may further comprise converting each page of each of the one or more related documents into a page image and computing an embedding for each of the page images.

In some embodiments, computing the embedding may further comprise separating each of the one or more related documents into text and images.

In some embodiments, text processing may then be performed on the separated text. The text processing may comprise defining a maximum word count and dividing the text into text chunks based on the maximum word count.

In some embodiments, image processing may also be performed on the separated image. The image processing may comprise treating each image as an independent image chunk and generating, by an image captioning model, a detailed caption for each image.

In some embodiments, each of the one or more related documents and the corresponding text and image chunks may be passed to the one or more machine learning models.

In some embodiments, the one or more machine learning models may be prompted to generate a context description for each of the chunks. The context description may then be concatenated with each chunk and the embedding may be generated as a context-chunk pair based on the chunk and its corresponding context description.

In some embodiments, the one or more complementary search indexes may comprise: a Term Frequency – Inverse Document Frequency (TF-IDF) index and/or a BM25 index.

In some embodiments, generating the initial question set may comprise inputting, into the one or more machine learning models, the intent and the detailed outlines of the one or more relevant documents and generating, for each of one or more topics, one or more questions. The one or more questions may then be categorized by question type. A prioritization process may be performed on the one or more questions.

The prioritization process may comprise scoring each of the one or more questions based on relevance to the intent and ranking, based on importance to a final structure corresponding to the report type, the one or more questions. One or more high priority questions may be flagging based on the scoring and ranking.

In some embodiments, recursively generating the one or more child questions may comprise generating an answer for each question and formulating, for each answer, one or more follow-up questions and generating a hierarchical question tree of parent-child question relationships. In some embodiments, hierarchical question tree may be configured to track question depth, detect and merge questions based on semantic similarity and perform cycle detection.

In some embodiments, generating an answer may comprise querying, for each question, the vector database using a plurality of retrieval method and receiving a query result for each of the retrieval methods. Results of each of the plurality of retrieval methods may then be merged. The answer may then be generated based on the question and merged results.

In some embodiments, the one or more machine learning models may be large language models (LLMs).

In some embodiments, the graphics generation module may be configured to perform, for each of the one or more graphic visualizations, an iterative generation process. The iterative generation process may comprise providing, to one or more LLMs, a graphic generation prompt to generate the graphic visualization,

In some embodiments, the graphic generation prompt may comprise the report outline, graphic examples extracted from the one or more related documents and/or textual information generated by the report generation module for the report outline section corresponding to the graphic visualization.

In some embodiments, a graphic generation loop may be performed. The graphic generation loop may comprise generating, by the one or more LLMs, graphics code for rendering the graphic visualization. An intermediate image may be rendered based on the graphics code. The one or more LLMs may then compare the intermediate image to the graphic examples. A graphic loop prompt may then be provided to the one or more LLMs comprising the intermediate image and instructions to make adjustments or corrections.

In some embodiments, comparing the intermediate image to the graphic examples may include calculating a visual correctness score. The graphic generation loop may be iterated until the visual correctness score exceeds a predetermined threshold and/or reaches a predetermined number of iterations.

In some embodiments, the iterative generation process may further comprise identifying one or more deficient graphic elements in the intermediate image. A type of deficiency corresponding to each of the one or more deficient graphic elements may be determined. One or more deficient element questions for each of the one or more deficient graphic elements may be generated based on the type of deficiency. Answers to the one or more deficient element questions may then be retrieved from the one or more data sources, the vector database or the one or more complementary indexes. The retrieved answers to the one or more deficient element questions may then be added, to the graphic loop prompt. The graphic loop prompt may then be provided to the one or more LLMs and the graphic generation loop may be iterated.

The appended claims may also serve as a summary of this application.

The features and components of these embodiments will be described in further detail in the description which follows. Additional features and advantages will also be set forth in the description which follows, and in part will be implicit from the description, or may be learned by the practice of the embodiments. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating an exemplary automated document planning and report generation system in which some embodiments may operate.

FIG. 2 is a diagram illustrating an exemplary application server in accordance with aspects of the present disclosure.

FIG. 3A is a flow chart illustrating an exemplary method that may be performed in accordance with some embodiments.

FIG. 3B is a flow chart illustrating an exemplary method that may be performed in accordance with some embodiments.

FIG. 3C is a flow chart illustrating an exemplary method that may be performed in accordance with some embodiments.

FIG. 3D is a flow chart illustrating an exemplary method that may be performed in accordance with some embodiments.

FIG. 4A is a diagram illustrating an exemplary report generation process flow in accordance with aspects of the present disclosure.

FIG. 4B is a diagram illustrating an exemplary generated report in accordance with aspects of the present disclosure.

FIG. 4C is a diagram illustrating an exemplary graphics generation process flow in accordance with aspects of the present disclosure.

FIG. 5 is a diagram illustrating an exemplary computer/control system that may perform processing in some embodiments and in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system and methods for the automated planning and generation of documents. In some embodiments, the system may be configured to take receive, from a user, an intent. The intent may include, and be associated with, one or more intended study types. The received intent may include one or more questions that the user intends to answer, reference to any other planning materials that are relevant and/or examples of a similar studies conducted by another municipality, organization or user.

In some embodiments, the received intent information may be processed by one or more machine learning models. In some embodiments, the one or more machine learning models may include large language models (LLMs).

In some embodiments, the LLM may be configured to formulate one or more initial queries to be used in an electronic resource review process. The initial queries may be used in a search engine or other searchable datastore to retrieve one or more relevant documents relevant to the received intent. In some embodiments, the retrieved one or more relevant document may include webpages, images, PDFs or other textual and/or graphical documents.

In some embodiments, an embedding may be generated for each retrieved document. Computation of embeddings may be document/data type specific. In some embodiments, a unified vector database may be generated based on the computed embeddings of the retrieved documents. In some embodiments, embeddings may be generated using multimodal modals.

In some embodiments, the system may be configured to create one or more indexes based on the text of the retrieved documents.

In some embodiments, the system may be configured to extract detailed outlines corresponding to the retrieved documents. The extraction may be based on an intent or report type and the content of the retrieved documents.

In some embodiments, the system may be configured to generate an initial question set. The LLM may ingest the intent, retrieved documents, and extracted detailed outlines and generated a comprehensive set of questions covering one or more major topics. The questions may be categorized by question type. For example, the questions may be categorized as factual, analytical, comparative, predictive, etc.

In some embodiments, the system may be configured to prioritize the generated questions. The prioritization may include scoring each question based on relevance to the study intent, ranking questions by importance to the final report structure and/or flagging high-priority questions for deeper exploration.

In some embodiments, the system may be configured to recursively generate questions based at least partially on answers received for previously answered questions. In some embodiments, the LLM may be an LLM with “retrieval augmented generation” (RAG). The RAG LLM may be used to answer the compiled list of questions and to recursively generate new questions. In some embodiment, the LLMs refer to both the unified vector DB for documents, as well as queries via search engine result pages.

For every answer, the system may also generate follow up questions. These follow up questions may be deduplicated by the LLM to ensure we do not answer the same question multiple times.

In some embodiments, the system may be configured identify when the LLM is unable to find the data for a particular question and raise an exception or otherwise indicate that the question requires additional information or resources to find an answer.

In some embodiments, the system may be configured to create a plan for the report based on the document outline and the answers for questions corresponding to the various sections of the. In some embodiments, the system may create bullet point outlines for various sections, including key information to highlight. The LLM may identify graphics and charts that would be most relevant to particular sections. The LLMs may then generate multiple candidate graphic or chart options for this outline.

In some embodiments, the system may be configured to generate various graphics, including maps, infographics, and charts. The LLM may process the input data and instruct the graphics generation module to create one or more graphical objects based on an analysis by the LLM. For maps, the LLM may reprocess the data in GIS format and generate HTML code to represent the legend. For infographics and charts, an input schema may be defined for each chart type (pie chart, bar chart, etc.). The LLM may be configured to reformat the data so it fits the input schema. The titles, labels, and additional context around the chart may also be generated by the LLM.

In some embodiments, the system may be configured to automatically generate the text of the report. The LLM may generate text for each section of the report based on the outline generated earlier and all of the answers to the questions.

A final report document may be generated by combining the generated text and graphics/charts/images with the outline.

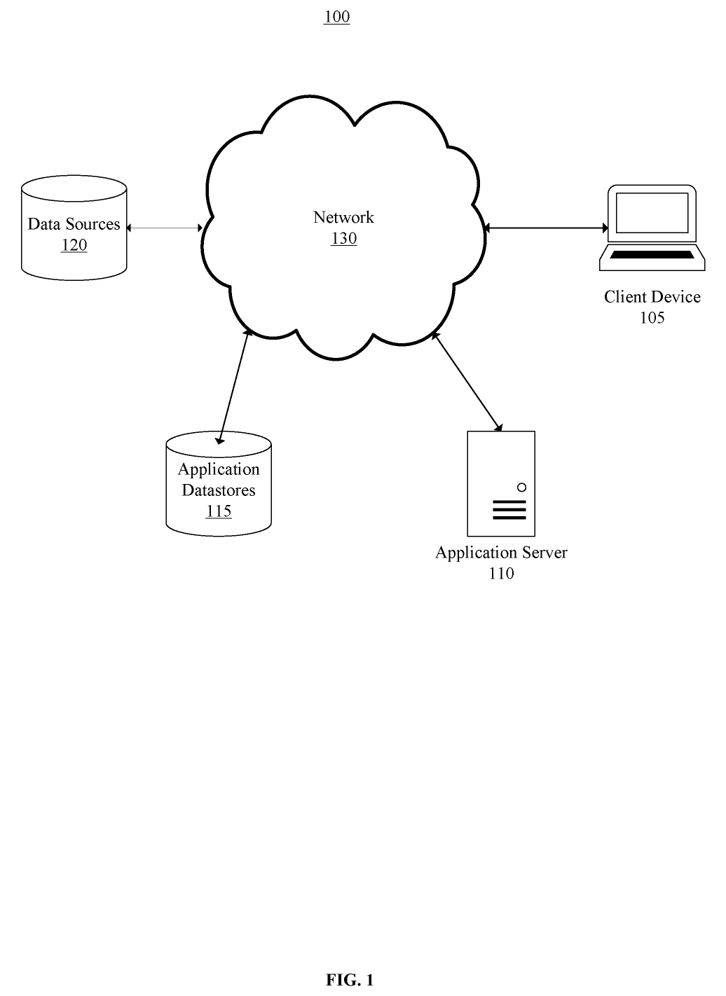

FIG. 1 is a diagram illustrating an exemplary report generation system 100 in which some embodiments may operate.

The report generation system 100 may comprise one or more client devices, 105, one or more application servers 110, one or more application datastores 115, one or more data sources 120 and a network 130.

The client devices 105 may be one or more physical or virtual machines configured to communicate with the one or more application servers 110, one or more application datastores 115 and one or more data sources over network 130.

The application servers 110 may be one or more physical or virtual machines configured to communicate with the one or more client devices 105, one or more application datastores 115 and one or more data sources 120. The one or more application servers 110 may be configured as a distributed computing infrastructure.

Application datastores 115 may communicate with one another over network 130. Application datastores 115 may be any storage device capable of storing data for processing or as a result of processing information at the client devices 105 and/or application servers 110. The application datastores 115 may be a separate device or the same device as application server 110. The application datastores 115 may be located in the same location as that of application servers 110, or at separate locations.

Data sources 120 may communicate with one another over network 130. Data sources 120 may be any storage device capable of storing data for processing or as a result of processing information. In some embodiments, the data sources 120 may include public data sources and/or private data sources. Data sources 120 may include databases, web servers, APIs, applications, models or other repositories of information. The data sources 120 may be located in the same location as application servers 110, or at separate locations.

Network 130 may be an intranet, internet, mesh, LTE, GSM, peer-to-peer or other communication network that allows the one or more client devices 105, application servers 110, application datastores 115 and data sources 120 to communicate with one another.

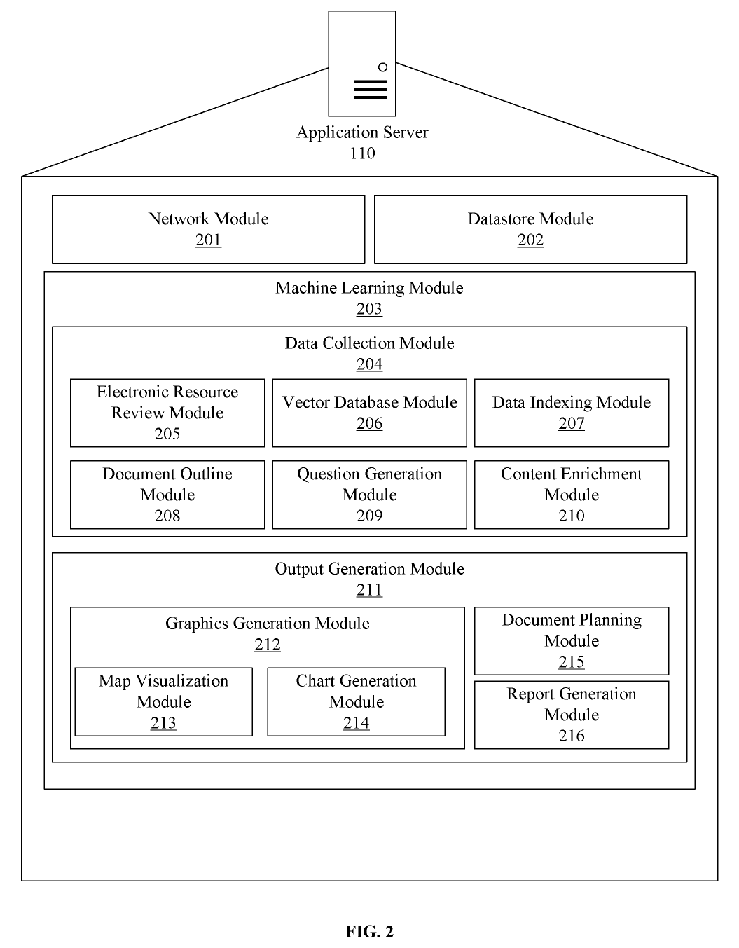

FIG. 2 is a diagram illustrating an exemplary application server 110 in accordance with aspects of the present disclosure. Application server 110 may comprise a network module 201, a datastore module 202 and machine learning module 203.

Network module 201 may transmit and receive data from other computing systems via a network such as network 130 as described above with regard to FIG. 1. In some embodiments, the network module 201 may enable transmitting and receiving data from the Internet. Data received by the network module 201 may be used by the other modules. The modules may transmit data through the network module 201.

The datastore module 202 may be configured to store information generated by the one or more modules operating on the application server 110. The one or more modules operating on the application server 110 may also retrieve information from the datastore module 202. Datastore module 202 may also be configured to receive and store information received over network module 201.

Machine learning module 203 may further comprise data collection module 203 and output generation module 211. The machine learning module 203 may comprise one or more LLMs. In some embodiments, the modules within the data collect module 204 and output generation module 211 may incorporate the one or more LLMs or generate prompts for the one or more LLMS that comprise machine learning module 203. In some embodiments, additional machine learning models/LLMs and information retrieval mechanisms may be used. In some embodiments, each module in the machine learning module 203 may be implemented as one or more LLMs.

The LLMs may be configured to perform retrieval augmented generation (RAG) to answer a compiled list of questions and to recursively generate new questions. The LLMs may refer to one or more vector databases compiled by the vector database module 206. The LLMs may also refer to queries via search engine result pages, API requests or other information retrieval systems.

Data collection module 204 may further comprise electronic resource review module 205, vector database module 206, data indexing module 207, document outline module 208, question generation module 209 and content enrichment module 210.

The electronic resource review module 205 may be configured to generate one or more search plans and/or strategies and generate one or more search queries for each of the search plans/strategies. The one or more search plans/strategies and their corresponding search queries may be source and API specific. In some embodiments, the electronic resource review module 205 may be configured to submit the generated search queries and received results of said queries. The results received may be stored in one or more application datastores 115.

In some embodiments, the vector database module 206 may be configured to generate one or more vector databases. The vector database creation may comprise creating one or more unified vector databases from all retrieved documents.

The process may be document type specific and source specific. For webpages, embeddings may be computed and stored in the one or more vector databases. For images, the embeddings may be computed using a multimodal model and stored in the one or more vector databases.

In some embodiments, documents may be processed using more than one approach. For example, PDFs may be processed as images and a combination of text and images. In some embodiments, processing may be performed in parallel .

Processing of documents as images, for example PDFs as images, may comprise converting each document page into an image, computing embeddings for each page-image and storing these embeddings in the one or more vector databases.

Processing documents as a combination of images and text may comprise a process of chunking. The chunking may include separating the document, such as a PDF, into text and images and processing the text and images in parallel separately.

In some embodiments, processing the text may comprise defining a maximum word count and dividing text into chunks based on this word count.

In some embodiments, each image may be treated as its own chunk. Each chunk may be processed using an image captioning model to create detailed captions. Context may then be added to each chunk. Creating the context may be performed by passing the entire document and the chunk to a multimodal language model. The multimodal language model may be incorporated into the vector database module 206, be a part of machine learning module 203 or be a part of a separate internal or external system. The model may then be prompted to generate a context description for the chunk. A final chunk may be created by concatenating the context description with each original chunk, embedding each (context, chunk) pair and adding these embeddings to the one or more vector databases.

Data indexing module 207 may be configured to generate one or more ranking databases. The one or more ranking databases may be generated using term frequency–inverse document frequency (“TFIDF”) model, bag- of-words model or best matching (“BM25”) model. In some embodiments, the one or more ranking databases may be generated using boolean models, vector space models and/or probabilistic models.

Document outline module 208 may be configured to generate one or more detailed outlines for each of the retrieved documents. The document outline module 208 may be configured to check, for each retrieved document, if it is a report matching the intent type. Checking for a match may comprise passing one or more pages of the retrieved document into an LLM of the document outline module. The document outline module 208 may then collect all the reports that match the intent type and extract a detailed outline of the reports. Each document may have a detailed outline generated.

Document outline module 208 may be configured to perform a detailed outline extraction process. Detailed outline extraction process may read over one or more reports or other documents and identify one or more graphical objects in each document, wherein the one or more graphical objects may include charts, graphs, maps or other forms of data visualizations. From the identified graphical objects, the document outline module 208 may identify which are relevant to the new report or document being generated. In some embodiments, a relevance score may be calculated for each of the one or more graphical objects and the identifying of relevant graphical objects may be based on said relevance score. In some embodiments, the graphical objects may be classified as relevant or not relevant. In some embodiments, additional classifications of the graphical objects may be used.

In some embodiments, a graphic interpretation process may be performed for each of the one or more graphical objects. The graphic interpretation process may be configured to determine a composition of each graphical object, the raw data used in generation of each graphical object, a correspondence between the raw data and the visualization generated for each of the graphical objects and the processes needed to generate the visualization of the graphical object.

For example, the LLM may identify a bar chart in a document as a relevant chart. For the identified chart, the graphic interpretation process may determine the type of chart, the type of data displayed and/or the organization of the data. For the identified bar chart, the graphic interpretation process may identify a type of bar chart, the categories represented by the bar chart and one or more organizational details of the bar chart. The interpretation process may then determine the raw data used for generating the bar chart. The interpretation process may also determine a format needed for the data to generate the graphical object. For example, the interpretation process may determine that a tabular format may be needed to generate said bar chart.

In some embodiments, the determination of the raw data may correspond to identifying one or more sources for the raw data and retrieving said data. In some embodiments, the determination of the raw data may correspond to extracting values from the graphical object or from the document the graphical object was originally extracted from. A combination of interpreting and extracting data from the document, the graphical object and external sources may be used in determining the raw data used in generation of the graphical object.

In some embodiments, the graphic interpretation process may be configured to create a graphic generation profile for each graphical object. The graphic generation profile may include information corresponding to the type of graphical object, the information needed for the graphical object to be generated, the format of the information, the organization of visual elements in the graphical element, and/or one or more queries or data requests used to retrieve said needed information.

Question generation module 209 may be configured to generate an initial question set and perform a recursive question expansion process. The initial question set may be created by generating a set of base questions. The base questions may be generated by inputting the study intent and collected document outlines to the LLM of the question generation module 209. A comprehensive set of primary questions covering all major topics may then be generated. The questions may be categorized by type. Types may include factual, analytical, comparative, predictive, etc.

A question prioritization process may then be performed wherein each question may be scored based on relevance to the study intent. Each question may then be ranked by importance to the final report structure and high-priority questions may be flagged for deeper exploration.

In some embodiments, the recursive question expansion may comprise the steps of answer generation, recursive question formulation and question tree management.

During answer generation, the question generation module 209 queries the vector database, for each question, to retrieve relevant information. Multiple retrieval methods may be used (vector similarity, TF-IDF, BM25) and the results may then be merged. One or more comprehensive answers may be generated using the LLM with retrieved content.

The recursive question formulation may comprise prompting the LLM for each answer, to generate follow-up questions. In some embodiments, the follow-up questions may focus on knowledge gaps identified in the answer, Unexplored implications or consequences, Alternative perspectives or contradictory evidence and/or deeper detail on key points.

In some embodiments, question tree management may comprise maintaining a hierarchical structure of parent-child question relationships and tracking question depth to limit recursion (e.g., max 3-4 levels deep). Semantic similarity may be used to detect and merge redundant questions. In some embodiments, cycle detection may be implemented to prevent circular questioning.

In some embodiments, the question generation module 209 may be configured to prompt the LLM to flag when it is unable to find the data for a particular question. In this case, the LLM may define a few options for data that might be necessary to answer the question, as well as any analyses that should be run. Each data request generated by the LLM may include an indicator on potential sources for the data. These could include the city government, satellite imagery, or field observations that need to be made.

Content enrichment module 210 may be configured to perform a targeted gap filling process. The targeted gap filling process may comprise, identifying information gaps by comparing question coverage against the one or more detailed. Targeted questions may then be generated for underrepresented sections. Questions that connect different sections/topics may be prioritized.

In some embodiments, the content enrichment module 210 may also be configured to perform a source diversity enhancement process. The source diversity enhancement process may include tracking the sources used in answers and generating questions specifically designed to incorporate underutilized sources. The content enrichment module 210 may further be configured to ensure multiple perspectives are represented on key topics.

Output generation module 211 may further comprise graphics generation module 212, document planning module 215, and report generation module 216.

Graphics generation module 212 may further comprise map visualization module 213 and chart generation module 214.

Output generation module 211 may be configured to generate a report or document based on the collected and generated data from the data collection module 204 and/or the modules within the data collection module.

The document planning module 215 may be configured to generate a report outline. The report outline may be based, at least in part, on the detailed outlines extracted for each of the one or more related documents.

In some embodiments, the report outline may include text and graphical information such as charts, graphs and maps. Other data visualizations may also be included in the report outline. In some embodiments, a type of graphical information and style of said graphical information may be determined based on analysis made by the document outline module 208.

The graphical information may be generated by the graphics generation module 212. The graphics generation module 212 may comprise map visualization module 213 and chart generation module 214.

Map visualization module 213 may be configured to generate one or more maps based on the intent of the report, location of the report, the extracted outline information from the document outline module 208, the generated report outline from the document planning module 215, data from the vector database module 206, one or more answers from retrieved by the question generation module 209 and/or other information generated or retrieved by the data collection module 204.

In some embodiments, the graphics generation module 212 may be configured to determine if it has the data needed to generate the graphical information in the report outline. In the case where the graphics generation module 212 does not have the data needed to generate the graphical information, the graphics generation module 212 may generate a notification that more data is needed. This notification may include details of what data is needed to generate the graphical information.

In some embodiments, when the needed information is not present, the graphics generation module 212 may be configured to collect the needed information automatically. One or more queries and/or requests for the needed information may be made to one or more data sources. In some embodiments, if the collection attempt is unsuccessful, the graphics generation module 212 may generate a notification in the same manner as described above.

In some embodiments, the graphics generation module 212 may be configured to use one or more LLMs to perform an iterative generation process. The iterative generation process may be configured to iteratively generate code and render graphics based on said generated code. Each iteration of generating code and rendering graphics may be compared to existing examples of code and graphics.

In some embodiments, the rendered graphics may be fed back into the LLM to perform the comparison.

In some embodiments, each comparison of generated code and/or the rendered graphics corresponding to said generated code may comprise calculating a visual correctness score. The visual correctness score may be based on similarities between the generated code/graphics and one or more relevant example documents.

In some embodiments, the iterative generation process may be performed for a predetermined number of iterations. In some embodiments, the iterative generation process may proceed until a threshold visual correctness score is reached. In some embodiments, a relevance metric may be computed for each iteration, wherein the relevance metric corresponds to how relevant the rendered graphics is to the intent of the report and/or how well it corresponds to the information collected.

In some embodiments, the iterative generation process may be performed on a graphics object as a whole.

In some embodiments, the graphics object may comprise one or more individual graphic elements. The iterative generation process may be performed on each individual element of the graphics object and a visual correctness score may be generated for each.

In some embodiments, the iterative generation process may be configured to identify one or more deficient elements in the graphic object and/or individual elements. Deficient elements may correspond to gaps in data, missing data, incorrect data, incomplete data and/or missing elements. In some embodiments, the deficiency identification may comprise determining a type of deficiency and how deficient the element/data are. In some embodiments, LLMs may be configured to generate one or more deficient element questions for each deficient element identified. The one or more deficient element questions may be based on the identified deficiency type, in what way the data/element is deficient, how deficient the data/element is, and what additional information is needed to resolve the deficiency. One or more data sources, both public and private, may be queried with the one or more deficient element questions. Responses to the one or more deficient element questions may be used to continue the iterative generation process.

In some embodiments, individual elements may be modified or removed based on the deficiency identification.

In some embodiments, one or more new individual elements may be generated/added to the graphic object based on the deficiency identification.

Report generation module 216 may be configured to generate, using one or more LLMS, one or more graphical objects corresponding to the graphical information of the report outline. The one or more LLMs may take data, as text or as data files, and generate code to render the one or more graphical objects. The LLMs may also use one or more graphic generation profiles created by the document outline module 208, as well as information generated/identified by the graphic interpretation process. In some embodiments, the LLMs may be configured to identify one or more graphics/visualization libraries to be used in generation of the graphical objects. The LLMs may select one or more of the identified libraries for generation of the one or more graphical objects. In some embodiments, a combination of libraries may be used to generate each of the one or more graphical objects.

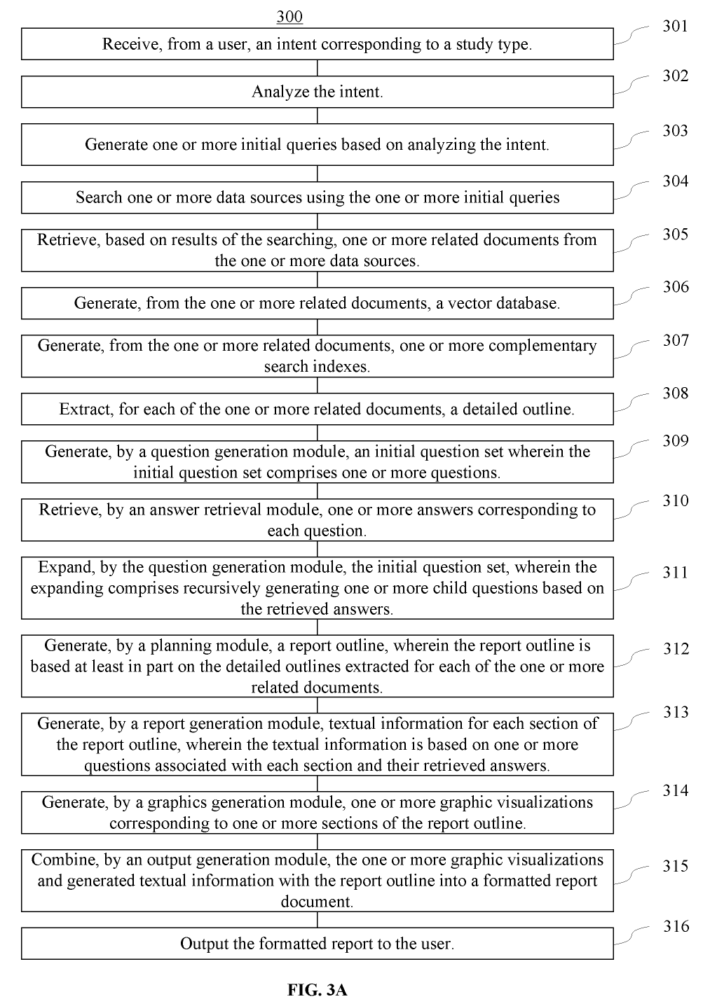

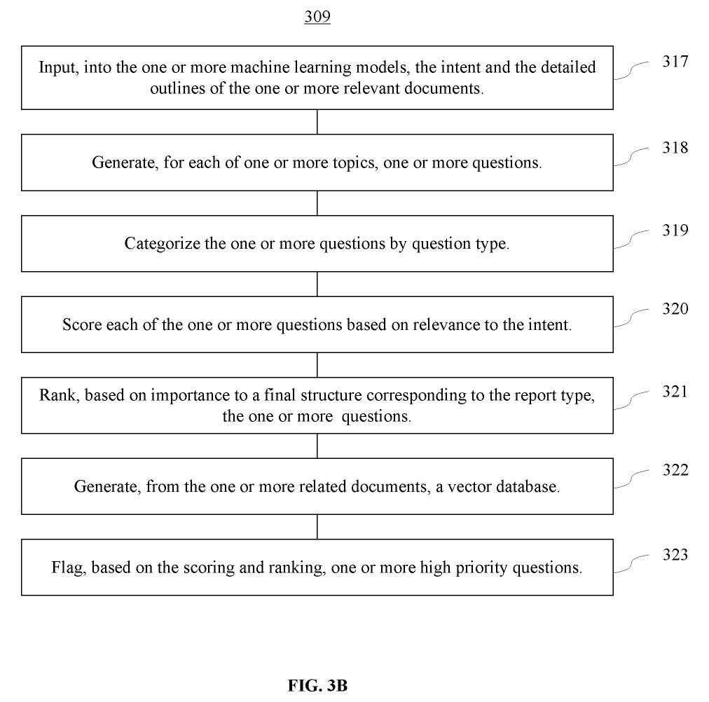

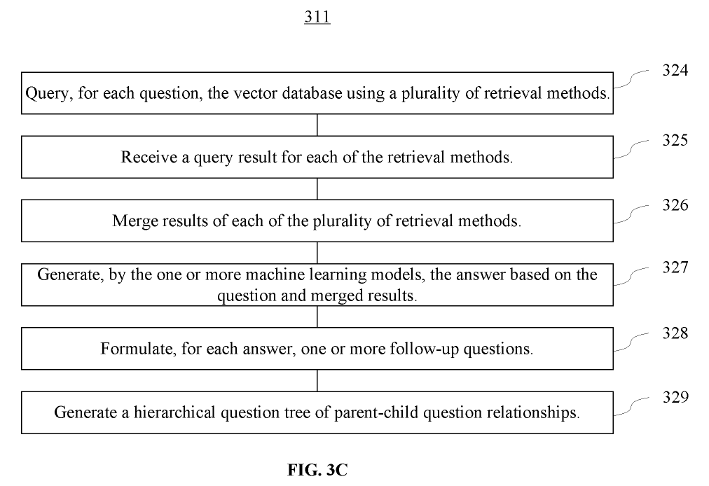

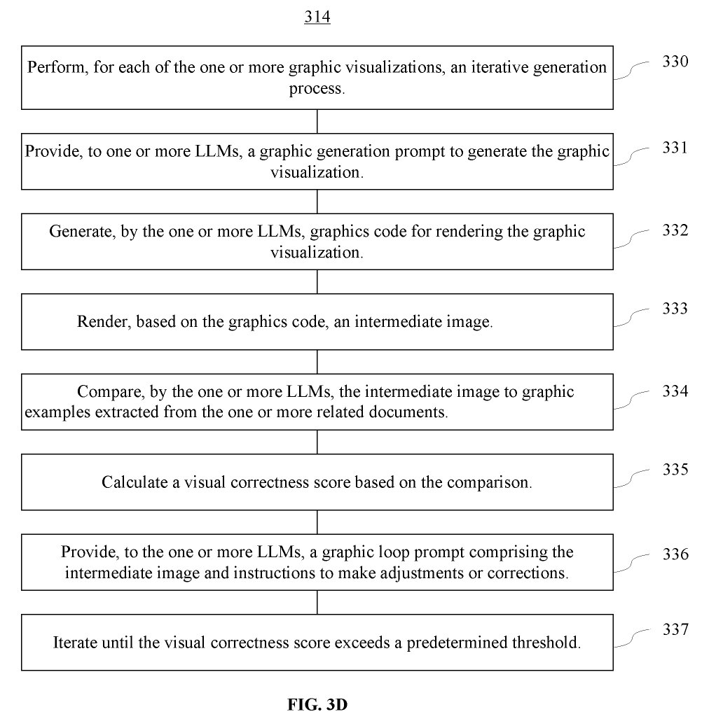

FIG. 3A is a flow chart illustrating an exemplary method for automatic report generation 300 that may be performed in accordance with some embodiments.

At step 301, the system is configurated to receive, from a user, an intent corresponding to a study type.

At step 302, the system is configurated to analyze, by a first machine learning model, the intent.

At step 303, the system is configurated to generate, by the first machine learning model, one or more initial queries based on analyzing the intent.

At step 304, the system is configurated to search one or more data sources using the one or more initial queries.

At step 305, the system is configurated to retrieve, based on results of the searching, one or more related documents from the one or more data sources.

At step 306, the system is configurated to generate, from the one or more related documents, a vector database.

At step 307, the system is configurated to generate, from the one or more related documents, one or more complementary search indexes.

At step 308, the system is configurated to extract, for each of the one or more related documents, a detailed outline.

At step 309, the system is configurated to generate, by a question generation module, an initial question set wherein the initial question set comprises one or more questions.

At step 310, the system is configurated to retrieve, by an answer retrieval module, one or more answers corresponding to each question.

At step 311, the system is configurated to expand, by the question generation module, the initial question set, wherein the expanding comprises recursively generating one or more child questions based on the retrieved answers.

At step 312, the system is configurated to generate, by a planning module, a report outline, wherein the report outline is based at least in part on the detailed outlines extracted for each of the one or more related documents.

At step 313, the system is configurated to generate, by a report generation module, textual information for each section of the report outline, wherein the textual information is based on one or more questions associated with each section and their retrieved answers.

At step 314, the system is configurated to generate, by a graphics generation module, one or more graphic visualizations corresponding to one or more sections of the report outline.

At step 315, the system is configurated to combine, by an output generation module, the one or more graphic visualizations and generated textual information with the report outline into a formatted report document.

At step 316, the system is configurated to output the formatted report to the user.

FIG. 3B is a flow chart illustrating an exemplary method 309 for question generation that may be performed in accordance with some embodiments.

At step 317, the system is configurated to input, into a second machine learning model, the intent and the detailed outlines of the one or more relevant documents.

At step 318, the system is configurated to generate, for each of one or more topics, one or more questions.

At step 319, the system is configurated to categorize the one or more questions by question type.

At step 320, the system is configurated to score each of the one or more questions based on relevance to the intent.

At step 321, the system is configurated to rank, based on importance to a final structure corresponding to the report type, the one or more questions.

At step 322, the system is configurated to generate, from the one or more related documents, a vector database.

At step 323, the system is configurated to flag, based on the scoring and ranking, one or more high priority questions.

FIG. 3C is a flow chart illustrating an exemplary method 311 for question expansion that may be performed in accordance with some embodiments.

At step 324, the system is configurated to query, for each question, the vector database using a plurality of retrieval methods.

At step 325, the system is configurated to receive a query result for each of the retrieval methods.

At step 326, the system is configurated to merge results of each of the plurality of retrieval methods.

At step 327, the system is configurated to generate, by the second machine learning model, the answer based on the question and merged results.

At step 328, the system is configurated to formulate, for each answer, one or more follow-up questions.

At step 329, the system is configurated to generate a hierarchical question tree of parent-child question relationships.

FIG. 3D is a flow chart illustrating an exemplary method 314 for the iterative generation of graphic visualizations.

At step 330, the system is configurated to perform, for each of the one or more graphic visualizations, an iterative generation process.

At step 331, the system is configurated to provide, to one or more LLMs, a graphic generation prompt to generate the graphic visualization. The graphic generation prompt may comprise the report outline, graphic examples extracted from the one or more related documents and textual information generated by the report generation module for the report outline section corresponding to the graphic visualization.

At step 332, the system is configurated to generate, by the one or more LLMs, graphics code for rendering the graphic visualization. In some embodiments, the graphics code may be HTML, CSS, JavaScript, Python or any markup language. In some embodiments, the graphics code may use one or more code libraries.

At step 333, the system is configurated to render, based on the graphics code, an intermediate image. In some embodiments, the rendering may be performed by a web browser or other application.

At step 334, the system is configurated to compare, by the one or more LLMs, the intermediate image to graphic examples extracted from the one or more related documents.

At step 335, the system is configurated to calculate a visual correctness score based on the comparison.

At step 336, the system is configurated to provide, to the one or more LLMs, a graphic loop prompt comprising the intermediate image and instructions to make adjustments or corrections.

At step 337, the system is configurated to iterate until the visual correctness score exceeds a predetermined threshold. In some embodiments, iteration may be limited to a maximum number of iterations.

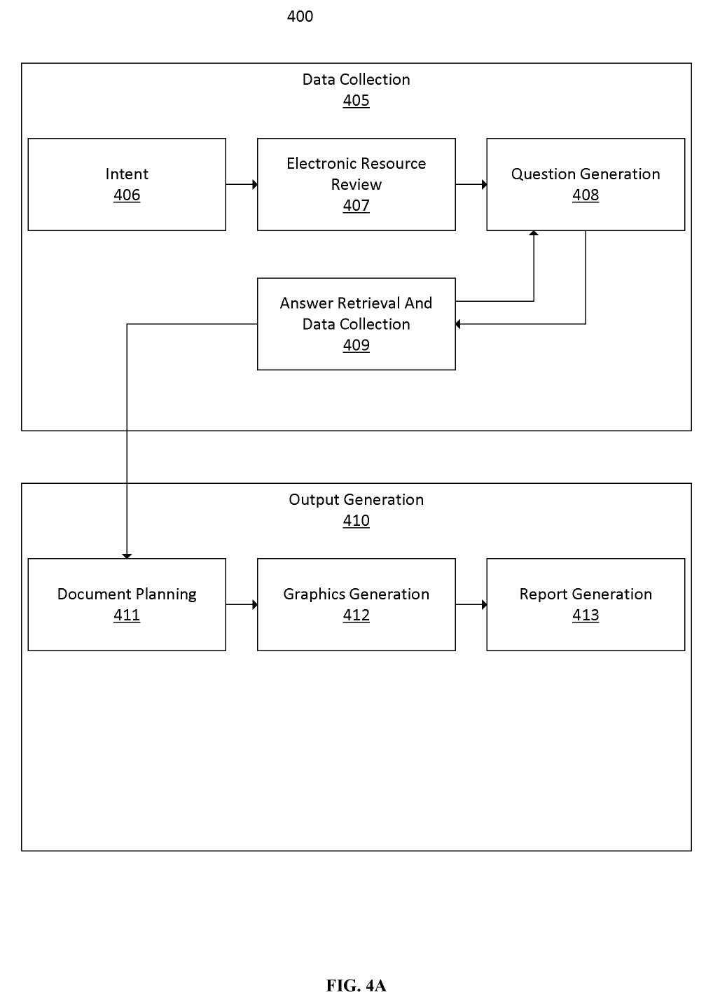

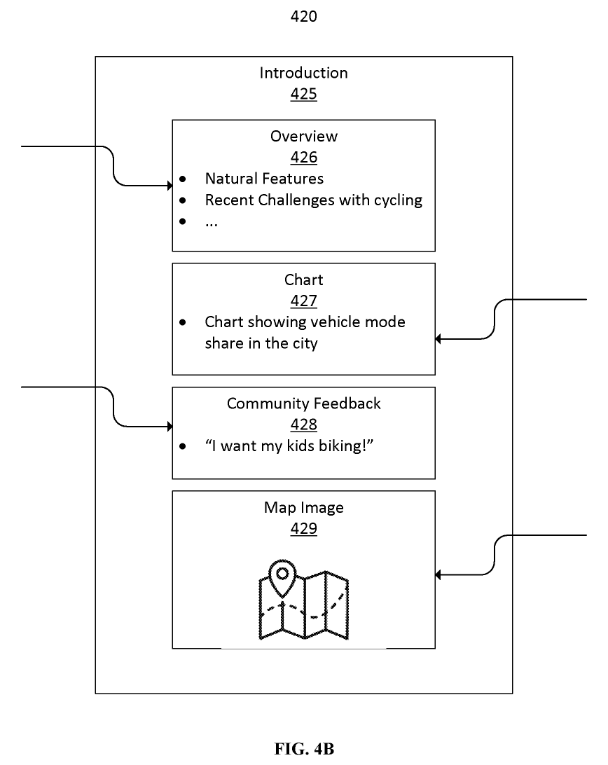

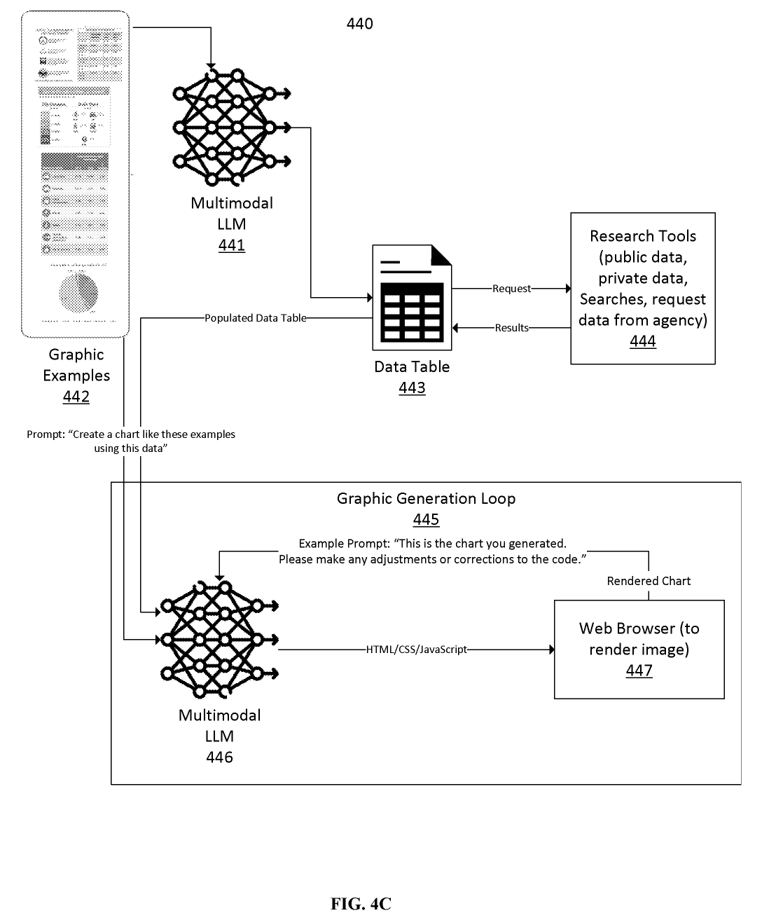

FIG. 4A is a diagram illustrating a report generation process flow 400 in accordance with aspects of the present disclosure.

The report generation process may comprise the steps of data collection 405 and output generation 410. Data collection may include receiving intent 406 from a user. The intent may include one or more questions to be answered, references to relevant information, examples of a previously generated studies or other relevant information.

Electronic resource review 407 may comprise initial query generation, vector database creation, additional indexing and document outline extractions.

In some embodiments, data from the intent 406 collection phase may be processed by one or more LLMs. The one or more LLMs may formulate initial queries for electronic resource review 407. These queries may be used in a search engines, APIs or forms of data retrieval to retrieve webpages, images, PDFs or other documents.

In some embodiments, vector database creation may comprise creating a unified vector database from all retrieved documents. The vector database creation process may be type specific. For webpages, embeddings may be computed directly and stored in the vector database. For images, the embeddings may be computed using a multimodal modal and stored in the vector database.

In some embodiments, some types of documents may be processed in more than one way. For example, PDF documents may be processed using two parallel approaches.

In some embodiments, PDFs may be processed as images and as chunks in parallel. The processing of PDFs as images may comprise converting each pdf page into an image, computing embeddings for each page-image and storing these embeddings in the vector database.

Processing the PDFs by chunking may comprise separating the pdf into text and images. The text may be processed by defining a maximum word count and dividing text into chunks based on this word count.

The images may be processed by treating each image as its own chunk. An image captioning model may be used to create detailed captions for the images.

In some embodiments, context may be added to each chunk. The context may be generated by passing the entire document and the chunk to a multimodal language model or other large language model, and prompting the model to generate a context description for the chunk.

Final chunks may be created by concatenating the context description with each original chunk, embed each (context, chunk) pair and adding these embeddings to the vector database.

Additional Indexing may be created including a TF-IDF index over the text and a BM25 index over the text. This may provide three complementary search indexes over all collected data.

In some embodiments, document outline extraction may be performed on the retrieved documents. For each PDF (document) retrieved, the electronic resource review 407 process may first check if it is a report matching the intent type. The matching may be performed by passing a one or more pages of the PDF or document into an LLM. All reports/documents that match the intent type may be collected and passed to an LLM to extract a detailed outline of the report.

Question generation 408 may comprise initial question set creation, base question generation, question prioritization and recursive question expansion. The initial question set creation may be based at least in part on the study intent and collected/received documents.

A recursive question expansion process may be performed between question generation 408 and answer retrieval and data collection 409. For every answer, follow up questions may be generated. These follow up questions may be deduplicated by an LLM to merge redundant questions.

Output generation 410 may receive data from data collection 405 and generate a formatted output report. Document planning 411 may be configured to generate a report outline based on one or more detailed outlines generated during data collection and the intent of the report. Based on the report outline and answers corresponding to questions associated with sections of the outline, a plan for generating the output report may be created. The planning may also use LLMs to identify graphics and charts that would be most relevant to particular sections. The LLMs may generate multiple candidate graphic or chart options for the report outline.

Graphics generation 412 may be configured to automatically generate various graphics, including maps, infographics, and charts. The graphics generation may use LLMs to process the input data and pass the results into one or more graphic generation APIs. For maps, the LLMs may reprocess the data in GIS format and generate HTML code to represent the legend. For infographics and charts, an input schema may be defined for each chart type (pie chart, bar chart, etc.). The LLMs may be reformat the data so it fits the input schema. The titles, labels, and additional context around the chart may also be generated by the LLMs.

Report generation 413 may be configured to generate the text of the report using the report outline generated during document planning 411 and all of the answers to the questions. The report outline and the answers may be provided to the LLM to generate the text for each section of the report. The text and graphics may be combined into a formatted output report and displayed or provided to the user.

FIG. 4B is a diagram illustrating an exemplary output report 420 generated by the process flow of FIG. 4B. The output report 420 may comprise multiple sections, wherein the sections may be determined based on analysis of detailed outlines extracted from one or more relevant documents. The output report 420 may be formatted based on a report outline comprising the one or more determined sections. Information for each of the one or more sections may be generated by one or more LLMs. The one or more LLMs may be provided with one or more prompts to retrieve information for each of the sections. Additional prompts may be provided to the LLMs with the retrieved information and instructions to generate content for each of the sections.

In some embodiments, the one or more LLMs may generate the output report 420 based on a schema or report outline and retrieved information for each section in the schema/report outline.

For example, the report outline used to generate the output report 420 illustrated in FIG. 4B may comprise sections for introduction, overview, charts, community feedback and maps. The LLMs may receive the report outline and generate one or more queries or questions for each of the sections in the report outline. These queries and/questions may be used in a prompt fed back into the one or more LLMs, sent to one or more different LLMs and/or used by an information retrieval mechanism to retrieve information from internal or external data sources (websites, databases, document repositories, etc.).

The retrieved information may be provided to the one or more LLMs along with instructions to generate an output report. The LLMs may generate textual information for one or more sections based on retrieved information corresponding to each section. Graphic objects may also be generated based on the retrieved information for each section corresponding to a graphic representation of the data.

As shown in FIG. 4B, the LLMs may generate a structured output report 420 comprises an introduction 425, an overview 426, a chart 427, community feedback 428 and a map image 429. The chart 427 and map image 429 may be graphical representations of data retrieved by the LLMs.

FIG. 4C is a diagram illustrating an exemplary graphics generation process flow 440 in in accordance with aspects of the present disclosure. Multimodal LLM 441 may be configured to receive one or more graphic example 442 from other reports or documents. LLM 441 may be configured to identify data required to generate one or more graphics objects in a report based on the received graphic examples and/or previous analysis/extraction results corresponding to said examples. A data table 443 may be generated based on the identified data and requests for said data may be sent to research tools 444. The results may then be used to fill in the data table 443. A prompt may be generated to create a graphical object using the data table 443 and the one or more graphic examples 442. Within a graphic generation loop 445, Multimodal LLM 446 may receive the prompt and generate code for rendering the requested graphical object. The generated code may be rendered by a web browser 447 or other rendering application. The graphic generation loop 445 may analyze the rendered graphical object, generate additional prompts, and send the additional prompt to the LLM 446 for further processing. Analysis of the rendered graphical object may be performed by LLM 441, LLM 446 or any system/LLM configured to perform a quality, relevance, similarity or correctness evaluation. In some embodiments, the loop may be performed a predetermined number of times. In some embodiments, the loop may be performed until the LLM 446 determines completion of the generation process. Determining completion may be based on a similarity metric, relevance metric, correctness metric or other metrics. In some embodiments, the loop may be performed until the determination of completion or a maximum number of iterations has been reached.

After completion, the generated graphic object may be added to a draft report or an output report.

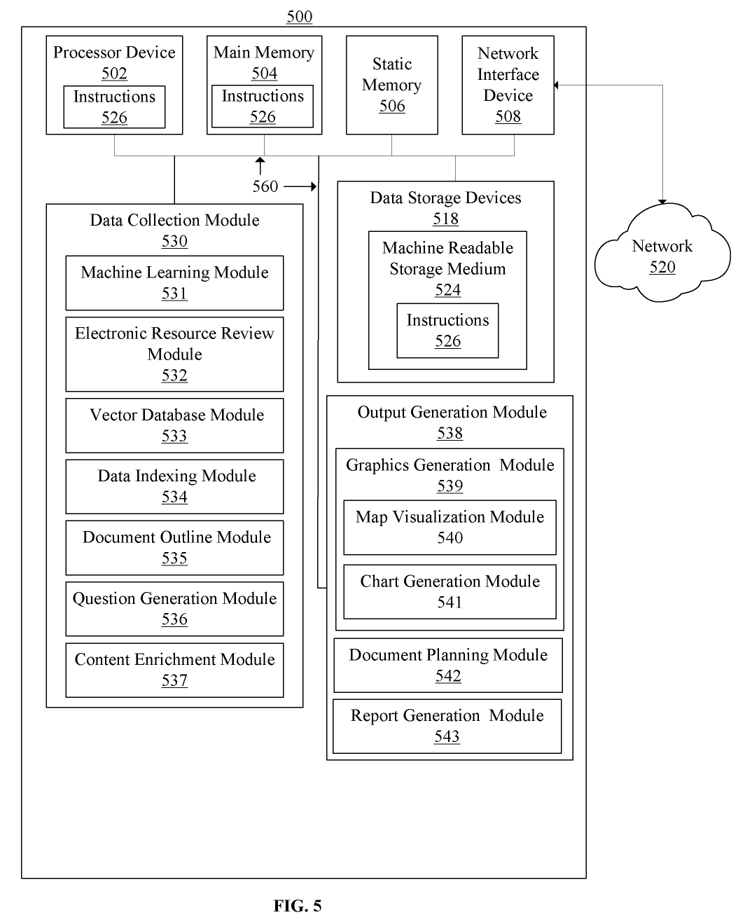

FIG. 5 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 560.

Processing device 502 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computer system 500 may further include a network interface device 508 to communicate over the network 520.

The computer system 500 may also include data collection module 530 and output generation module 538.

Data collection module 530 may further comprise machine learning module 531, electronic resource review module 532, vector database module 533, data indexing module 534, document outline module 535, question generation module 536 and content enrichment module 537.

Output generation module 538 may further comprise graphics generation module 539, document planning module 542, and report generation module 543.

Graphics generation module 539 may further comprise map visualization module 540 and chart generation module 541.

Data collection module 530, machine learning module 531, electronic resource review module 532, vector database module 533, data indexing module 534, document outline module 535, question generation module 536, content enrichment module 537, output generation module 538, graphics generation module 539, map visualization module 540 and chart generation module 541, document planning module 542, and report generation module 543 may be the same or similar to that of Data collection module 203, machine learning module 204, electronic resource review module 205, vector database module 206, data indexing module 207, document outline module 208, question generation module 209, content enrichment module 210, output generation module 211, graphics generation module 212, map visualization module 213 and chart generation module 214, document planning module 215, and report generation module 216 as disclosed in FIG. 2.

The data storage device 518 may include a machine-readable storage medium 524 (also known as a computer-readable medium) on which is stored one or more sets of instructions or software 526 embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media. Information, including data used in the processes and methods of the system and the one or more sets of instructions or software, may also be stored in blockchain, as NFTs or other decentralized technologies.

In one implementation, the instructions 526 include instructions to implement functionality corresponding to the components of a device to perform the disclosure herein. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

It will be appreciated that the present disclosure may include any one and up to all of the following examples.

Example 1. An automated study generation system, wherein the system comprises: An application server, wherein the application server is configured to generate a report, wherein the report generation is performed by one or more machine learning models, and wherein the report generation comprises: receiving, from a user, an intent corresponding to a study type; performing, by an electronic resource review module, an electronic resource review, wherein the electronic resource review comprises: analyzing the intent; generating one or more initial queries based on analyzing the intent; searching one or more data sources using the one or more initial queries; retrieving, based on results of the searching, one or more related documents from the one or more data sources; generating, from the one or more related documents, a vector database; generating, from the one or more related documents, one or more complementary search indexes; and extracting, for each of the one or more related documents, a detailed outline; generating, by a question generation module, an initial question set wherein the initial question set comprises one or more questions; retrieving, by an answer retrieval module, one or more answers corresponding to each question; expanding, by the question generation module, the initial question set, wherein the expanding comprises recursively generating one or more child questions based on the retrieved answers; generating, by a planning module, a report outline, wherein the report outline is based at least in part on the detailed outlines extracted for each of the one or more related documents; generating, by a graphics generation module, one or more graphic visualizations corresponding to one or more sections of the report outline; generating, by a report generation module, textual information for each section of the report outline, wherein the textual information is based on one or more questions associated with each section and their retrieved answers; combining , by an output generation module, the one or more graphic visualizations and generated textual information with the report outline into a formatted report document; and outputting the formatted report to the user.

Example 2. The method of Example 1, wherein the intent comprises: one or more questions to be answered; references to relevant information; and an example of a previously generated study.

Example 3. The method of any one of Examples 1-2, wherein generating the vector database comprises: determining, for each of the one or more related documents, a document type; and computing, for each of the one or more related documents, an embedding, wherein computing the embedding is based at least in part on the determined document type.

Example 4. The method of any one of Examples 1-3, wherein computing the embedding further comprises: converting each page of each of the one or more related documents into a page image; and computing an embedding for each of the page images.

Example 5. The method of any one of Examples 1-4, wherein computing the embedding further comprises: separating each of the one or more related documents into text and images; performing text processing on the separated text, wherein the text processing comprises: defining a maximum word count; and dividing the text into text chunks based on the maximum word count; performing image processing on the separated image, wherein the image processing comprises: treating each image as an independent image chunk; and generating, by an image captioning model, a detailed caption for each image; passing, to the one or more machine learning models, each of the one or more related documents and the corresponding text and image chunks; prompting the one or more machine learning models to generate a context description for each of the chunks; concatenating the context description with each chunk; and generating the embedding as a context-chunk pair based on the chunk and its corresponding context description.

Example 6. The method of any one of Examples 1-5, wherein the one or more complementary search indexes comprise: a TF-IDF index; and a BM25 index.

Example 7. The method of any one of Examples 1-6, wherein generating the initial question set comprises: inputting, into the one or more machine learning models, the intent and the detailed outlines of the one or more relevant documents; generating, for each of one or more topics, one or more questions; categorizing the one or more questions by question type; and performing a prioritization process on the one or more questions, wherein the prioritization process comprises: scoring each of the one or more questions based on relevance to the intent; ranking, based on importance to a final structure corresponding to the report type, the one or more questions; and flagging, based on the scoring and ranking, one or more high priority questions.

Example 8. The method of any one of Examples 1-7, wherein the recursively generating the one or more child questions comprises: generating an answer for each question; formulating, for each answer, one or more follow-up questions; and generating a hierarchical question tree of parent-child question relationships.

Example 9. The method of any one of Examples 1-8, wherein generating an answer comprises: querying, for each question, the vector database using a plurality of retrieval methods; receiving a query result for each of the retrieval methods; merging results of each of the plurality of retrieval methods; and generating, by the one or more machine learning models, the answer based on the question and merged results.

Example 10. The method of any one of Examples 1-9, wherein the hierarchical question tree is configured to: track question depth; detect and merge questions based on semantic similarity; and perform cycle detection.

Example 11. The method of any one of Examples 1-10, wherein the one or more machine learning models are large language models (LLMs).

Example 12. The system of any one of Examples 1-11, wherein the graphics generation module is configured to perform, for each of the one or more graphic visualizations, an iterative generation process, wherein the iterative generation process comprises: providing, to one or more LLMs, a graphic generation prompt to generate the graphic visualization, wherein the graphic generation prompt comprises: the report outline; graphic examples extracted from the one or more related documents; and textual information generated by the report generation module for the report outline section corresponding to the graphic visualization; performing a graphic generation loop, wherein the graphic generation loop comprises: generating, by the one or more LLMs, graphics code for rendering the graphic visualization; rendering, based on the graphics code, an intermediate image; comparing, by the one or more LLMs, the intermediate image to the graphic examples; and providing, to the one or more LLMs, a graphic loop prompt comprising the intermediate image and instructions to make adjustments or corrections.

Example 13. The system of any one of Examples 1-12, wherein comparing the intermediate image to the graphic examples includes calculating a visual correctness score.

Example 14. The system of any one of Examples 1-13, wherein the graphic generation loop is iterated until the visual correctness score exceeds a predetermined threshold.

Example 15. The system of any one of Examples 1-14, wherein the iterative generation process further comprises: identifying one or more deficient graphic elements in the intermediate image; determining a type of deficiency corresponding to each of the one or more deficient graphic elements; generating, based on the type of deficiency, one or more deficient element questions for each of the one or more deficient graphic elements; retrieving, from the one or more data sources, the vector database or the one or more complementary indexes, answers to the one or more deficient element questions; adding, to the graphic loop prompt, the retrieved answers to the one or more deficient element questions; and providing, to the one or more LLMs, the graphic loop prompt; and iterating the graphic generation loop.

Example 16. A method for automated study generation, wherein the method comprises: receiving, by an application server, an intent corresponding to a study type from a user and wherein the intent comprises: one or more questions to be answered; references to relevant information; and an example of a previously generated study; performing, by one or more large language models (LLMs) of an electronic resource review module executed on the application server, an electronic resource review, wherein the electronic resource review comprises: analyzing the intent; generating one or more initial queries based on analyzing the intent; searching one or more data sources using the one or more initial queries; retrieving, based on results of the searching, one or more related documents from the one or more data sources; generating, from the one or more related documents, a vector database, wherein generating the vector database comprises: determining, for each of the one or more related documents, a document type; and computing, for each of the one or more related documents, an embedding, wherein computing the embedding is based at least in part on the determined document type and comprises: separating each of the one or more related documents into text and images; performing text processing on the separated text, wherein the text processing comprises: defining a maximum word count; and dividing the text into text chunks based on the maximum word count; performing image processing on the separated image, wherein the image processing comprises: treating each image as an independent image chunk; and generating, by an image captioning model, a detailed caption for each image; passing, to the one or more machine learning models, each of the one or more related documents and the corresponding text and image chunks; prompting the one or more machine learning models to generate a context description for each of the chunks; concatenating the context description with each chunk; and generating the embedding as a context-chunk pair based on the chunk and its corresponding context description; generating, from the one or more related documents, one or more complementary search indexes, wherein the one or more complementary search indexes comprise a term frequency – inverse document frequency (TF-IDF) index and a BM25 index; extracting, for each of the one or more related documents, a detailed outline; generating, by a question generation module, an initial question set wherein the initial question set comprises one or more questions and wherein generating the initial question set comprises: inputting, into the one or more LLMs, the intent and the detailed outlines of the one or more relevant documents; generating, for each of one or more topics, one or more questions; categorizing the one or more questions by question type; and performing a prioritization process on the one or more questions, wherein the prioritization process comprises: scoring each of the one or more questions based on relevance to the intent; ranking, based on importance to a final structure corresponding to the report type, the one or more questions; and flagging, based on the scoring and ranking, one or more high priority questions; retrieving, by an answer retrieval module, one or more answers corresponding to each question; expanding, by the question generation module, the initial question set, wherein the expanding comprises recursively generating one or more child questions based on the retrieved answers, and wherein recursively generating the one or more child questions comprises: generating an answer for each question, wherein generating an answer comprises: querying, for each question, the vector database using a plurality of retrieval methods; receiving a query result for each of the retrieval methods; merging results of each of the plurality of retrieval methods; and generating, by the one or more LLMs, the answer based on the question and merged results; formulating, for each answer, one or more follow-up questions; and generating a hierarchical question tree of parent-child question relationships wherein the hierarchical question tree is configured to: track question depth; detect and merge questions based on semantic similarity; and perform cycle detection; generating, by a planning module, a report outline, wherein the report outline is based at least in part on the detailed outlines extracted for each of the one or more related documents; generating, by a report generation module, textual information for each section of the report outline, wherein the textual information is based on one or more questions associated with each section and their retrieved answers; generating, by a graphics generation module, one or more graphic visualizations corresponding to one or more sections of the report outline, wherein the graphics generation module is configured to perform, for each of the one or more graphic visualizations, an iterative generation process, wherein the iterative generation process comprises: providing, to the one or more LLMs, a graphic generation prompt to generate the graphic visualization, wherein the graphic generation prompt comprises: the report outline; graphic examples extracted from the one or more related documents; and textual information generated by the report generation module for the report outline section corresponding to the graphic visualization; performing a graphic generation loop, wherein the graphic generation loop comprises: generating, by the one or more LLMs, graphics code for rendering the graphic visualization; rendering, based on the graphics code, an intermediate image; comparing, by the one or more LLMs, the intermediate image to the graphic examples, wherein the comparing comprises calculating a visual correctness score; providing, to the one or more LLMs, a graphic loop prompt comprising the intermediate image and instructions to make adjustments or corrections; and iterating the graphic generation loop until the visual correctness score exceeds a predetermined threshold; combining , by an output generation module, the one or more graphic visualizations and generated textual information with the report outline into a formatted report document; and outputting the formatted report to the user.

Example 17. The method of Example 16, wherein the iterative generation process further comprises: identifying one or more deficient graphic elements in the intermediate image; determining a type of deficiency corresponding to each of the one or more deficient graphic elements; generating, based on the type of deficiency, one or more deficient element questions for each of the one or more deficient graphic elements; retrieving, from the one or more data sources, the vector database or the one or more complementary indexes, answers to the one or more deficient element questions; adding, to the graphic loop prompt, the retrieved answers to the one or more deficient element questions; and providing, to the one or more LLMs, the graphic loop prompt; and iterating the graphic generation loop.

Example 18. A non-transitory computer readable medium having instructions stored thereon that, when executed by a processing device, cause the processing device to perform operations comprising: receiving, by an application server, an intent corresponding to a study type from a user and wherein the intent comprises: one or more questions to be answered; references to relevant information; and an example of a previously generated study; performing, by one or more large language models (LLMs) of an electronic resource review module executed on the application server, an electronic resource review, wherein the electronic resource review comprises: analyzing the intent; generating one or more initial queries based on analyzing the intent; searching one or more data sources using the one or more initial queries; retrieving, based on results of the searching, one or more related documents from the one or more data sources; generating, from the one or more related documents, a vector database, wherein generating the vector database comprises: determining, for each of the one or more related documents, a document type; and computing, for each of the one or more related documents, an embedding, wherein computing the embedding is based at least in part on the determined document type and comprises: separating each of the one or more related documents into text and images; performing text processing on the separated text, wherein the text processing comprises: defining a maximum word count; and dividing the text into text chunks based on the maximum word count; performing image processing on the separated image, wherein the image processing comprises: treating each image as an independent image chunk; and generating, by an image captioning model, a detailed caption for each image; passing, to the one or more machine learning models, each of the one or more related documents and the corresponding text and image chunks; prompting the one or more machine learning models to generate a context description for each of the chunks; concatenating the context description with each chunk; and generating the embedding as a context-chunk pair based on the chunk and its corresponding context description; generating, from the one or more related documents, one or more complementary search indexes, wherein the one or more complementary search indexes comprise a term frequency – inverse document frequency (TF-IDF) index and a BM25 index; extracting, for each of the one or more related documents, a detailed outline; generating, by a question generation module, an initial question set wherein the initial question set comprises one or more questions and wherein generating the initial question set comprises: inputting, into the one or more LLMs, the intent and the detailed outlines of the one or more relevant documents; generating, for each of one or more topics, one or more questions; categorizing the one or more questions by question type; and performing a prioritization process on the one or more questions, wherein the prioritization process comprises: scoring each of the one or more questions based on relevance to the intent; ranking, based on importance to a final structure corresponding to the report type, the one or more questions; and flagging, based on the scoring and ranking, one or more high priority questions; retrieving, by an answer retrieval module, one or more answers corresponding to each question; expanding, by the question generation module, the initial question set, wherein the expanding comprises recursively generating one or more child questions based on the retrieved answers, and wherein recursively generating the one or more child questions comprises: generating an answer for each question, wherein generating an answer comprises: querying, for each question, the vector database using a plurality of retrieval methods; receiving a query result for each of the retrieval methods; merging results of each of the plurality of retrieval methods; and generating, by the one or more LLMs, the answer based on the question and merged results; formulating, for each answer, one or more follow-up questions; and generating a hierarchical question tree of parent-child question relationships wherein the hierarchical question tree is configured to: track question depth; detect and merge questions based on semantic similarity; and perform cycle detection; generating, by a planning module, a report outline, wherein the report outline is based at least in part on the detailed outlines extracted for each of the one or more related documents; generating, by a report generation module, textual information for each section of the report outline, wherein the textual information is based on one or more questions associated with each section and their retrieved answers; generating, by a graphics generation module, one or more graphic visualizations corresponding to one or more sections of the report outline, wherein the graphics generation module is configured to perform, for each of the one or more graphic visualizations, an iterative generation process, wherein the iterative generation process comprises: providing, to the one or more LLMs, a graphic generation prompt to generate the graphic visualization, wherein the graphic generation prompt comprises: the report outline; graphic examples extracted from the one or more related documents; and textual information generated by the report generation module for the report outline section corresponding to the graphic visualization; performing a graphic generation loop, wherein the graphic generation loop comprises: generating, by the one or more LLMs, graphics code for rendering the graphic visualization; rendering, based on the graphics code, an intermediate image; comparing, by the one or more LLMs, the intermediate image to the graphic examples, wherein the comparing comprises calculating a visual correctness score; providing, to the one or more LLMs, a graphic loop prompt comprising the intermediate image and instructions to make adjustments or corrections; and iterating the graphic generation loop until the visual correctness score exceeds a predetermined threshold; combining , by an output generation module, the one or more graphic visualizations and generated textual information with the report outline into a formatted report document; and outputting the formatted report to the user.

Example 19. The method of Example 18, wherein the iterative generation process further comprises: identifying one or more deficient graphic elements in the intermediate image; determining a type of deficiency corresponding to each of the one or more deficient graphic elements; generating, based on the type of deficiency, one or more deficient element questions for each of the one or more deficient graphic elements; retrieving, from the one or more data sources, the vector database or the one or more complementary indexes, answers to the one or more deficient element questions; adding, to the graphic loop prompt, the retrieved answers to the one or more deficient element questions; and providing, to the one or more LLMs, the graphic loop prompt; and iterating the graphic generation loop.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as "identifying" or “determining” or "executing" or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. An automated study generation system, wherein the system comprises:
An application server, wherein the application server is configured to generate a report, wherein the report generation is performed by one or more machine learning models, and wherein the report generation comprises:
receiving, from a user, an intent corresponding to a study type;
performing, by an electronic resource review module, an electronic resource review, wherein the electronic resource review comprises:
analyzing the intent;
generating one or more initial queries based on analyzing the intent;
searching one or more data sources using the one or more initial queries;
retrieving, based on results of the searching, one or more related documents from the one or more data sources;
generating, from the one or more related documents, a vector database;
generating, from the one or more related documents, one or more complementary search indexes; and
extracting, for each of the one or more related documents, a detailed outline;
generating, by a question generation module, an initial question set wherein the initial question set comprises one or more questions;
retrieving, by an answer retrieval module, one or more answers corresponding to each question;
expanding, by the question generation module, the initial question set, wherein the expanding comprises recursively generating one or more child questions based on the retrieved answers;
generating, by a planning module, a report outline, wherein the report outline is based at least in part on the detailed outlines extracted for each of the one or more related documents;
generating, by a graphics generation module, one or more graphic visualizations corresponding to one or more sections of the report outline;
generating, by a report generation module, textual information for each section of the report outline, wherein the textual information is based on one or more questions associated with each section and their retrieved answers;
combining , by an output generation module, the one or more graphic visualizations and generated textual information with the report outline into a formatted report document; and
outputting the formatted report to the user.

2. The system of claim 1, wherein the intent comprises:
one or more questions to be answered;
references to relevant information; and
an example of a previously generated study.

3. The system of claim 2, wherein generating the vector database comprises:
determining, for each of the one or more related documents, a document type; and
computing, for each of the one or more related documents, an embedding, wherein computing the embedding is based at least in part on the determined document type.

4. The system of claim 3, wherein computing the embedding further comprises:
converting each page of each of the one or more related documents into a page image; and
computing an embedding for each of the page images.

5. The system of claim 4, wherein computing the embedding further comprises:
separating each of the one or more related documents into text and images;
performing text processing on the separated text, wherein the text processing comprises:
defining a maximum word count; and
dividing the text into text chunks based on the maximum word count;
performing image processing on the separated image, wherein the image processing comprises:
treating each image as an independent image chunk; and
generating, by an image captioning model, a detailed caption for each image;
passing, to the one or more machine learning models, each of the one or more related documents and the corresponding text and image chunks;
prompting the one or more machine learning models to generate a context description for each of the chunks;
concatenating the context description with each chunk; and
generating the embedding as a context-chunk pair based on the chunk and its corresponding context description.

6. The system of claim 5, wherein the one or more complementary search indexes comprise:
a TF-IDF index; and
a BM25 index.

7. The system of claim 6, wherein generating the initial question set comprises:
inputting, into the one or more machine learning models, the intent and the detailed outlines of the one or more relevant documents;
generating, for each of one or more topics, one or more questions;
categorizing the one or more questions by question type; and
performing a prioritization process on the one or more questions, wherein the prioritization process comprises:
scoring each of the one or more questions based on relevance to the intent;
ranking, based on importance to a final structure corresponding to the report type, the one or more questions; and
flagging, based on the scoring and ranking, one or more high priority questions.

8. The system of claim 7, wherein the recursively generating the one or more child questions comprises:
generating an answer for each question;
formulating, for each answer, one or more follow-up questions; and
generating a hierarchical question tree of parent-child question relationships.

9. The system of claim 8, wherein generating an answer comprises:
querying, for each question, the vector database using a plurality of retrieval methods;
receiving a query result for each of the retrieval methods;
merging results of each of the plurality of retrieval methods; and
generating, by the one or more machine learning models, the answer based on the question and merged results.

10. The system of claim 9, wherein the hierarchical question tree is configured to:
track question depth;
detect and merge questions based on semantic similarity; and
perform cycle detection.

11. The system of claim 10, wherein the one or more machine learning models are large language models (LLMs).

12. The system of claim 11, wherein the graphics generation module is configured to perform, for each of the one or more graphic visualizations, an iterative generation process, wherein the iterative generation process comprises:
providing, to one or more LLMs, a graphic generation prompt to generate the graphic visualization, wherein the graphic generation prompt comprises:
the report outline;
graphic examples extracted from the one or more related documents; and
textual information generated by the report generation module for the report outline section corresponding to the graphic visualization;
performing a graphic generation loop, wherein the graphic generation loop comprises:
generating, by the one or more LLMs, graphics code for rendering the graphic visualization;
rendering, based on the graphics code, an intermediate image;
comparing, by the one or more LLMs, the intermediate image to the graphic examples; and
providing, to the one or more LLMs, a graphic loop prompt comprising the intermediate image and instructions to make adjustments or corrections.

13. The system of claim 12, wherein comparing the intermediate image to the graphic examples includes calculating a visual correctness score.

14. The system of claim 13, wherein the graphic generation loop is iterated until the visual correctness score exceeds a predetermined threshold.

15. The system of claim 14, wherein the iterative generation process further comprises:
identifying one or more deficient graphic elements in the intermediate image;
determining a type of deficiency corresponding to each of the one or more deficient graphic elements;
generating, based on the type of deficiency, one or more deficient element questions for each of the one or more deficient graphic elements;
retrieving, from the one or more data sources, the vector database or the one or more complementary indexes, answers to the one or more deficient element questions;
adding, to the graphic loop prompt, the retrieved answers to the one or more deficient element questions; and
providing, to the one or more LLMs, the graphic loop prompt; and
iterating the graphic generation loop.

16. A method for automated study generation, wherein the method comprises:
receiving, by an application server, an intent corresponding to a study type from a user and wherein the intent comprises:
one or more questions to be answered;
references to relevant information; and
an example of a previously generated study;
performing, by one or more large language models (LLMs) of an electronic resource review module executed on the application server, an electronic resource review, wherein the electronic resource review comprises:
analyzing the intent;
generating one or more initial queries based on analyzing the intent;
searching one or more data sources using the one or more initial queries;
retrieving, based on results of the searching, one or more related documents from the one or more data sources;
generating, from the one or more related documents, a vector database, wherein generating the vector database comprises:
determining, for each of the one or more related documents, a document type; and
computing, for each of the one or more related documents, an embedding, wherein computing the embedding is based at least in part on the determined document type and comprises:
separating each of the one or more related documents into text and images;
performing text processing on the separated text, wherein the text processing comprises:
defining a maximum word count; and
dividing the text into text chunks based on the maximum word count;
performing image processing on the separated image, wherein the image processing comprises:
treating each image as an independent image chunk; and
generating, by an image captioning model, a detailed caption for each image;
passing, to the one or more machine learning models, each of the one or more related documents and the corresponding text and image chunks;
prompting the one or more machine learning models to generate a context description for each of the chunks;
concatenating the context description with each chunk; and
generating the embedding as a context-chunk pair based on the chunk and its corresponding context description;
generating, from the one or more related documents, one or more complementary search indexes, wherein the one or more complementary search indexes comprise a term frequency – inverse document frequency (TF-IDF) index and a BM25 index;
extracting, for each of the one or more related documents, a detailed outline;
generating, by a question generation module, an initial question set wherein the initial question set comprises one or more questions and wherein generating the initial question set comprises:
inputting, into the one or more LLMs, the intent and the detailed outlines of the one or more relevant documents;
generating, for each of one or more topics, one or more questions;
categorizing the one or more questions by question type; and
performing a prioritization process on the one or more questions, wherein the prioritization process comprises:
scoring each of the one or more questions based on relevance to the intent;
ranking, based on importance to a final structure corresponding to the report type, the one or more questions; and
flagging, based on the scoring and ranking, one or more high priority questions;
retrieving, by an answer retrieval module, one or more answers corresponding to each question;
expanding, by the question generation module, the initial question set, wherein the expanding comprises recursively generating one or more child questions based on the retrieved answers, and wherein recursively generating the one or more child questions comprises:
generating an answer for each question, wherein generating an answer comprises:
querying, for each question, the vector database using a plurality of retrieval methods;
receiving a query result for each of the retrieval methods;
merging results of each of the plurality of retrieval methods; and
generating, by the one or more LLMs, the answer based on the question and merged results;
formulating, for each answer, one or more follow-up questions; and
generating a hierarchical question tree of parent-child question relationships wherein the hierarchical question tree is configured to:
track question depth;
detect and merge questions based on semantic similarity; and
perform cycle detection;
generating, by a planning module, a report outline, wherein the report outline is based at least in part on the detailed outlines extracted for each of the one or more related documents;
generating, by a report generation module, textual information for each section of the report outline, wherein the textual information is based on one or more questions associated with each section and their retrieved answers;
generating, by a graphics generation module, one or more graphic visualizations corresponding to one or more sections of the report outline, wherein the graphics generation module is configured to perform, for each of the one or more graphic visualizations, an iterative generation process, wherein the iterative generation process comprises:
providing, to the one or more LLMs, a graphic generation prompt to generate the graphic visualization, wherein the graphic generation prompt comprises:
the report outline;
graphic examples extracted from the one or more related documents; and
textual information generated by the report generation module for the report outline section corresponding to the graphic visualization;
performing a graphic generation loop, wherein the graphic generation loop comprises:
generating, by the one or more LLMs, graphics code for rendering the graphic visualization;
rendering, based on the graphics code, an intermediate image;
comparing, by the one or more LLMs, the intermediate image to the graphic examples, wherein the comparing comprises calculating a visual correctness score;
providing, to the one or more LLMs, a graphic loop prompt comprising the intermediate image and instructions to make adjustments or corrections; and
iterating the graphic generation loop until the visual correctness score exceeds a predetermined threshold;
combining , by an output generation module, the one or more graphic visualizations and generated textual information with the report outline into a formatted report document; and
outputting the formatted report to the user.

17. The method of claim 16, wherein the iterative generation process further comprises:
identifying one or more deficient graphic elements in the intermediate image;
determining a type of deficiency corresponding to each of the one or more deficient graphic elements;
generating, based on the type of deficiency, one or more deficient element questions for each of the one or more deficient graphic elements;
retrieving, from the one or more data sources, the vector database or the one or more complementary indexes, answers to the one or more deficient element questions;
adding, to the graphic loop prompt, the retrieved answers to the one or more deficient element questions; and
providing, to the one or more LLMs, the graphic loop prompt; and
iterating the graphic generation loop.

18. A non-transitory computer readable medium having instructions stored thereon that, when executed by a processing device, cause the processing device to perform operations comprising:
receiving, by an application server, an intent corresponding to a study type from a user and wherein the intent comprises:
one or more questions to be answered;
references to relevant information; and
an example of a previously generated study;
performing, by one or more large language models (LLMs) of an electronic resource review module executed on the application server, an electronic resource review, wherein the electronic resource review comprises:
analyzing the intent;
generating one or more initial queries based on analyzing the intent;
searching one or more data sources using the one or more initial queries;
retrieving, based on results of the searching, one or more related documents from the one or more data sources;
generating, from the one or more related documents, a vector database, wherein generating the vector database comprises:
determining, for each of the one or more related documents, a document type; and
computing, for each of the one or more related documents, an embedding, wherein computing the embedding is based at least in part on the determined document type and comprises:
separating each of the one or more related documents into text and images;
performing text processing on the separated text, wherein the text processing comprises:
defining a maximum word count; and
dividing the text into text chunks based on the maximum word count;
performing image processing on the separated image, wherein the image processing comprises:
treating each image as an independent image chunk; and
generating, by an image captioning model, a detailed caption for each image;
passing, to the one or more machine learning models, each of the one or more related documents and the corresponding text and image chunks;
prompting the one or more machine learning models to generate a context description for each of the chunks;
concatenating the context description with each chunk; and
generating the embedding as a context-chunk pair based on the chunk and its corresponding context description;
generating, from the one or more related documents, one or more complementary search indexes, wherein the one or more complementary search indexes comprise a term frequency – inverse document frequency (TF-IDF) index and a BM25 index;
extracting, for each of the one or more related documents, a detailed outline;
generating, by a question generation module, an initial question set wherein the initial question set comprises one or more questions and wherein generating the initial question set comprises:
inputting, into the one or more LLMs, the intent and the detailed outlines of the one or more relevant documents;
generating, for each of one or more topics, one or more questions;
categorizing the one or more questions by question type; and
performing a prioritization process on the one or more questions, wherein the prioritization process comprises:
scoring each of the one or more questions based on relevance to the intent;
ranking, based on importance to a final structure corresponding to the report type, the one or more questions; and
flagging, based on the scoring and ranking, one or more high priority questions;
retrieving, by an answer retrieval module, one or more answers corresponding to each question;
expanding, by the question generation module, the initial question set, wherein the expanding comprises recursively generating one or more child questions based on the retrieved answers, and wherein recursively generating the one or more child questions comprises:
generating an answer for each question, wherein generating an answer comprises:
querying, for each question, the vector database using a plurality of retrieval methods;
receiving a query result for each of the retrieval methods;
merging results of each of the plurality of retrieval methods; and
generating, by the one or more LLMs, the answer based on the question and merged results;
formulating, for each answer, one or more follow-up questions; and
generating a hierarchical question tree of parent-child question relationships wherein the hierarchical question tree is configured to:
track question depth;
detect and merge questions based on semantic similarity; and
perform cycle detection;
generating, by a planning module, a report outline, wherein the report outline is based at least in part on the detailed outlines extracted for each of the one or more related documents;
generating, by a report generation module, textual information for each section of the report outline, wherein the textual information is based on one or more questions associated with each section and their retrieved answers;
generating, by a graphics generation module, one or more graphic visualizations corresponding to one or more sections of the report outline, wherein the graphics generation module is configured to perform, for each of the one or more graphic visualizations, an iterative generation process, wherein the iterative generation process comprises:
providing, to the one or more LLMs, a graphic generation prompt to generate the graphic visualization, wherein the graphic generation prompt comprises:
the report outline;
graphic examples extracted from the one or more related documents; and
textual information generated by the report generation module for the report outline section corresponding to the graphic visualization;
performing a graphic generation loop, wherein the graphic generation loop comprises:
generating, by the one or more LLMs, graphics code for rendering the graphic visualization;
rendering, based on the graphics code, an intermediate image;
comparing, by the one or more LLMs, the intermediate image to the graphic examples, wherein the comparing comprises calculating a visual correctness score;
providing, to the one or more LLMs, a graphic loop prompt comprising the intermediate image and instructions to make adjustments or corrections; and
iterating the graphic generation loop until the visual correctness score exceeds a predetermined threshold;
combining , by an output generation module, the one or more graphic visualizations and generated textual information with the report outline into a formatted report document; and
outputting the formatted report to the user.

19. The non-transitory computer readable medium of claim 18, wherein the iterative generation process further comprises:
identifying one or more deficient graphic elements in the intermediate image;
determining a type of deficiency corresponding to each of the one or more deficient graphic elements;
generating, based on the type of deficiency, one or more deficient element questions for each of the one or more deficient graphic elements;
retrieving, from the one or more data sources, the vector database or the one or more complementary indexes, answers to the one or more deficient element questions;
adding, to the graphic loop prompt, the retrieved answers to the one or more deficient element questions; and
providing, to the one or more LLMs, the graphic loop prompt; and
iterating the graphic generation loop.
